(19) United States
(12) Patent Application Publication
(10) Pub. No.: US 2015/0255002 A1
(43) Pub. Date: Sep. 10, 2015

(54) PERSONAL TRAINING SYSTEM AND RELATED EXERCISE FACILITY AND METHOD

(71) Applicant: HAI Logan Gym, LLC, Logan, UT (US)

(72) Inventors: Robert D. Harris, Logan, UT (US); Blake Harris, Logan, UT (US)

(73) Assignee: HAI LOGAN GYM, LLC, Logan, UT (US)

(21) Appl. No.: 14/716,498

(22) Filed: May 19, 2015

Related U.S. Application Data
(63) Continuation-in-part of application No. 14/469,423, filed on Aug. 26, 2014.
Application No. 14/469,423 is a continuation-in-part of application No. 14/287,444, filed on May 27, 2014.
Application No. 14/287,444 is a continuation-in-part of application No. 14/012,754, filed on Aug. 28, 2013.
(60) Provisional application No. 61/828,489, filed on May 29, 2013.
(60) Provisional application No. 61/816,510, filed on Apr. 26, 2013.
(60) Provisional application No. 61/694,126, filed on Aug. 28, 2012.

(51) Int. Cl. G09B 19/00; G09B 5/02; E04H 1/02; E04H 1/12; G09B 5/00; E04H 1/00

(52) U.S. Cl. CPC G09B 19/003; G09B 5/00; E04H 1/005; E04H 1/02; E04H 1/125; G09B 5/02

(57) ABSTRACT

A plurality of private booths are provided for users to perform exercises of an exercise regimen. The exercise regimen is based upon user input and fitness and test results. The user is provided a predetermined amount of time to perform a goal-number of repetitions of the exercise within each booth, and is guided from booth-to-booth to provide the different exercises of the exercise regimen.

### RELATED APPLICATION

This application is a continuation-in-part of U.S. application Ser. No. 14/469,423, filed on Aug. 26, 2014, which is a continuation-in-part of U.S. application Ser. No. 14/287,444, filed May 27, 2014, and is a continuation-in-part of U.S. application Ser. No. 14/012,754, filed Aug. 28, 2013, which claims the benefit of U.S. Provisional Application Ser. No. 61/828,489, filed May 29, 2013, U.S. Provisional Application Ser. No. 61/816,510, filed Apr. 26, 2013, and U.S. Provisional Application Ser. No. 61/694,126, filed Aug. 28, 2012.

### BACKGROUND OF THE INVENTION

The present invention generally relates to the field of health and fitness. More particularly, the present invention relates to an exercise facility wherein members can exercise privately. Moreover, the present invention relates to a method and system for providing a user with a personal exercise program which can be varied according to the user's needs.

Today more than ever before, individuals are becoming more aware of their own physical fitness and the need to exercise. People follow exercise programs for a variety of reasons. These reasons include maintaining general well-being, assisting a weight loss program, and increased muscular definition or power.

Scientific evidence has established that exercise is known to improve and maximize individual health and to constrain the effects of aging. The proven benefits of fitness training often include, for example, increased muscle mass, lower resting heart rate, decreased cholesterol levels, lower blood pressure, and less stress on joints. To achieve these benefits, a consistent exercise program spanning an extended period of time is usually required.

In order to offer exercisers a complete and balanced program, exercise facilities typically include strength equipment that work targeted muscle groups as well as cardiovascular machines. New facilities or “gyms” are being opened nearly every day to provide a place where individuals can go to work out on various kinds of equipment and physical fitness devices. Modern exercise equipment is typically capable of adjustment to accommodate different fitness levels, i.e., a difficulty or resistance setting is usually provided that can increase or decrease the amount of exertion that it takes to operate the machine, thereby making it possible for a single machine to accommodate users over a wide range of ability levels. Gyms which include such exercise equipment are especially helpful and convenient for individuals who must sit at a desk and work during the day and get very little if any physical exercise, and for a relatively low monthly rate provides access to a fairly large number of exercise devices.

However, traditional gyms provide a limited number of stand-alone pieces of exercise equipment, or stations, on which to accomplish these exercises. Moreover, each device typically can only be used to perform a small set of specifically targeted exercises, for example, a triceps machine is operated by a user to exercise the user's triceps muscles, the target muscle.

The relative popularity of different types of machinery dictates the unique capacity of each machine. For example, men are usually far more likely to use a bench press than they are to use a leg abductor machine. Despite the numerous choices of exercise machines, it is a common occurrence to find increased demand for a certain type of equipment, wherein the demand is often larger than the capacity. Since the devices can only be in active use by one individual at a time, and each individual's exercise program is personal to that individual, there is often contention for pieces of exercise equipment between multiple individuals, resulting in bottlenecking or user downtime. Frequent bottlenecking during peak times is very disruptive to a workout program, often resulting in inefficient and time-consuming workouts. Many times an individual cannot achieve a regular workout and measure the individual's accomplishments because when the individual is ready to exercise with a certain type of equipment, that equipment is being used by another member of the gym. Frequently, if the next station or device is being used by someone else, a person will either cut short a workout session and/or skip one or more stations thereby precluding the achievement of a maximum benefit workout.

Although the multi-fold benefits of physical exercise are well established, most users are pressed for time and seek to maximize the benefit of such time as they have. Due to the increased demands on people's lives, exercisers are requiring more efficient use of their limited time at the gym. At the same time, gym operators typically have limited budgets and are not able to typically purchase more equipment to accommodate increased usage. Additionally, spending money on equipment for purchases requires more floor space into which to fit the additional equipment and increases the total maintenance cost for keeping all the equipment in working order.

Although the above-described problem of not having a particular station or exercise device available when the user desires occurs in some instances, in other instances users are simply overwhelmed with the large number of machines, stations, etc. Given the equipment that is available, the user can create a program from an almost limitless number of possible permutations. This can be overwhelming to those who are starting an exercise program using gym equipment for the first time. The uneducated user may not understand or appreciate the purpose of each of the machines or stations, and may not have a cohesive or effective exercise program. In such instances, the user may utilize only a few machines which they are comfortable with, without realizing the benefits of a fully integrated exercise program.

In the best case, an individual will work with a personal trainer in order to obtain the benefits of experience and customization of a workout for that particular individual. Personal trainers, coaches and the like often desire that the clients under their care and advisement follow a predetermined set of exercises to help the client improve in a desired area or to reach a particular fitness goal or just to prescribe a general fitness protocol or program. However, as might be expected, it can be difficult for a busy client to keep track of the trainer's recommended workout program and to track his or her own performance while following that plan. A strength program must be well planned in order to be effective. For example, a strength program may include exercises for every muscle group at resistance levels based on personal fitness levels. As fitness levels change, the resistance level should also be changed. Planning and tracking is typically a manual process. Workouts are manually recorded in log books by either the client or his or her trainer, in the event that the trainer accompanies and is present with the client during the exercise program.

However, using a personal trainer is expensive. Furthermore, while a personal trainer is useful in some cases, each trainer's knowledge varies and the end experience is random regarding achieving the preferred effects of a customized workout. Aside from monetary considerations by the user, some people are simply not interested in having someone else evaluate their personal performance and look over their shoulder and pressure them to increase their strength and fitness levels. In those instances when a personal trainer is periodically consulted with, the prescribed workout program given to the exerciser by the trainer may not fit the exerciser's ability on any given day. For example, if the exerciser has a cold, didn't get enough sleep the night before, etc., that exerciser may not have the strength or mental fortitude to accomplish the prescribed exercise program.

Of course, providing administrators, trainers, physiologists, and the like increase the gym owner's cost of operating the gym. However, in traditional gyms such individuals are typically necessary to meet the needs of at least some of the member users.

Another disadvantage of traditional gyms is the matter of privacy. The majority of gyms have both male and female users which belong to the gym and exercise there on a regular basis. This can create a level of discomfort in some individuals when working out. There is a wide disparity of muscular strength and fitness levels between these individuals. Some users feel as if they are being judged, looked upon critically, or even “checked out” while exercising. The public nature of gyms creates a fair degree of anxiety and self-consciousness in many members. In fact, many individuals who are interested in obtaining a workout at the facilities provided by a public gym are not willing to attend the gym due to these concerns. There has been a recent development in the opening of women-only gyms where only women are the patrons in order to overcome some of these concerns. However, these women-only gyms also cater to a wide range of women having different muscular strength, fitness levels, body types and the like so that only some of these concerns are alleviated.

Accordingly, there is a need for a new type of exercise system, including an exercise facility which addresses the desire for users thereof to work out in privacy, obtain an effective full body workout in a reasonable amount of time, and have access to all necessary equipment during the workout or exercise regimen. The present invention fulfills these needs, and provides other related advantages.

### SUMMARY OF THE INVENTION

The present invention is directed to an exercise system and related exercise facility and method which provide privacy to the users of the exercise facility while performing an established exercise regimen within a reasonable amount of time without undue prior planning by the user before performing the exercises. In accordance with the invention, the exercises to be performed in accordance with the exercise regimen is pre-established as well as the amount of time taken to perform a goal-number of repetitions of each exercise to be performed. Furthermore, each user will have access to all the necessary equipment when needed during the workout or exercise regimen.

In accordance with the present invention, a plurality of booths are provided, such as in an exercise facility. Each booth defines an enclosed space adapted to be used by a single user at a time and configured to provide privacy to the user while in the booth. Each booth has assigned thereto a predetermined exercise to be performed by the user within the booth. A plurality of exercise devices are disposed within a respective plurality of the booths for performing the assigned exercises within those booths.

Each exercise device within the booths includes a categorized range of resistance or weight. Such may be indicated by indicia associated with the exercise device, such as color coding indicia of the resistance or weight ranges. The range of resistance or weight of each exercise device is divided into a plurality of categories.

Prior to entering the booths, and in order to create a personalized exercise regimen for the user, the user selects a desired fitness program. These may include a general fitness and caloric burn program, a strength enhancing program, or a performance power program. A goal-number of repetitions to be performed for each exercise is assigned to the user based on the selected desired fitness program and assigned exercise time period. The exercise regimen further comprises a predetermined resistance or weight category to be used during the exercise by the user. The assignment of the resistance or weight category may include the step of the user performing an initial fitness determination test prior to exercising. An initial fitness determination test may comprise a grip strength test. The initial fitness determination test may additionally or alternatively comprise performing a single repetition of an exercise at a given resistance or weight and adjusting the resistance or weight upwardly or downwardly based on determination of an ability to complete the assigned number of repetitions within the assigned exercise time for the exercise.

Upon entering a booth to perform an exercise in accordance with the exercise regimen, an electronic screen is provided within each booth for displaying information relating to the exercise to be performed within that booth, such as a tutorial for the exercise to be performed by the user in that booth. A timer is also disposed within each booth for conveying to the user the amount of remaining time to complete the exercise within the booth. The timer may comprise a second electronic screen disposed within each booth. The time of the timers in the booths are derived from the same source or synchronized.

The user attempts to perform the goal-number of repetitions of the exercise to be performed in each booth at a given weight or resistance within the predetermined time period. A visual and/or audible notification of the time period to complete the exercise within each booth is provided. The user is then directed to perform a sequence of exercises by moving from one booth to another in a predetermined sequence, each exercise being assigned a time period to complete the exercise and a number of repetitions of the exercise to be performed by the user.

The plurality of booths comprises at least five booths in close proximity or adjacent to one another. The plurality of booths corresponding to the sequence of exercises of an exercise regimen may comprise between five and thirty booths disposed adjacent to one another and passed through by the user at least once during the exercise regimen to perform the sequence of exercises. The booths may include indicia or may be arranged in a sequence in which the user is directed to move from one booth to another to perform different exercises corresponding to the sequence of exercises of the exercise regimen to be performed by the user.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of a plurality of booths of a workout area of an exercise facility, used in accordance with the present invention;

FIG. 2 is a front elevational view of an entrance to a booth;

FIG. 3 is a perspective view of a booth, having a wall removed therefrom for purposes of illustration, illustrating an entry, an exit, an exercise device and a display screen, in accordance with the present invention;

FIG. 4 is a fragmented perspective view of electrical outlet cutouts of a frame of the booth, used in accordance with the present invention;

FIG. 5 is a perspective view of electrical wiring and outlets disposed within the frame of the booth, in accordance with the present invention;

FIG. 6 is a perspective view of an electronic display screen within a booth, in accordance with the present invention;

FIG. 7 is a fragmented perspective view of a tool used for placing or removing walls of the booths;

FIG. 8 is a side diagrammatic view illustrating interconnection of locking members of booth members;

FIGS. 9a and 9b are male and female interconnecting members, respectively, used in accordance with the present invention;

FIG. 10 is a perspective view illustrating the movement of a wall of a booth, in accordance with the present invention;

FIG. 11 is a front elevational view of a booth having a wall removed therefrom and used in accordance with the present invention;

FIG. 12 is a perspective view of an exercise device attached to upper framework of a booth, in accordance with the present invention;

FIG. 13 is a table depicting an exemplary workout regimen generated in accordance with the present invention;

FIG. 14 is a diagrammatic view of a plurality of booths assigned an exercise, in accordance with the present invention;

FIG. 15 is a diagrammatic view of an exercise facility embodying the present invention;

FIG. 16 is a diagrammatic view illustrating a computerized system used in accordance with the present invention;

FIG. 17 is a flowchart depicting the steps taken in assigning exercises to a plurality of booths used in accordance with the present invention;

FIG. 18 is a flowchart depicting the steps of a member or user registration, in accordance with the present invention;

FIG. 19 is a flowchart depicting making reservations for the exercise facility of the present invention;

FIG. 20 is a table illustrating exemplary start times and flow through booths for several users or members of the present invention;

FIG. 21 is a flowchart depicting the steps taken in cancelling an exercise session using the present invention;

FIG. 22 is a diagram illustrating the display of an electronic screen within the booth and used in accordance with the present invention;

FIG. 23 is a depiction of an electronic screen providing a timer prior to entering a booth of the exercise facility;

FIG. 24 is an enlarged perspective view of a range of weights of an exercise device, and indicia associated with each category of weights, in accordance with the prevent invention, and a selection of a weight or resistance category;

FIG. 25 is a perspective view of a user performing an exercise within a booth, in accordance with the present invention; and

FIG. 26 is a diagrammatic view of an electronic screen displaying a timer and an indication to proceed to the next booth.

### DETAILED DESCRIPTION OF THE PREFERRED EMBODIMENTS

The present invention is directed to an exercise facility, sometimes referred to herein as a gym, and personal training system wherein each of the users (sometimes referred to herein as members, patrons, clients, individuals or exercisers) are able to perform their exercises in a private setting, so as to overcome the anxiety and self-consciousness of exercising in front of others. Each exercise is performed in a substantially enclosed area, referred to herein as a booth. It will be appreciated that the term “booth” represents a substantially concealed and private area which may comprise an individual room, which may be defined by walls, dividers, curtains, etc. which provide the exercise anonymity and privacy while performing the exercise. Each booth is configured to be used by a single user at a time. Typically, each booth will have the exercise equipment necessary within it to perform an exercise assigned to the user as the user passes therethrough, as will be more fully explained herein. The exercise equipment may comprise a single exercise device. The exercise device may be configured to be used for only a single exercise, or may be multi-functional in that it has the configuration to perform multiple exercises, however, only a single exercise will be performed at a given time by a user who passes through the booth.

In a particularly preferred embodiment, an exercise device, such as a piece of exercise equipment or machinery, exercise mats, exercise devices, etc. as needed is placed in each booth, such that the user moves from one booth to another in order to perform a different exercise in each booth using different exercise machines, devices, etc. Typically, the user is provided an individually personalized exercise program, such that the user moves from one booth to another in order to perform different exercises at a level of repetitions and resistance specific to that user, as described more fully below.

The present invention incorporates a comprehensive, personalized exercise program for individuals that want to be directed by professionals, while maintaining the privacy they desire without having to spend additional funds for a personal trainer. A user who wishes to achieve personal fitness or improve upon sports-related skills is offered a workout program and the facilities to achieve their goals within a defined period of time. The workout programs are based on established sports physiology and personal fitness procedures. The method and system of the present invention provides users a workout that is unique to the fitness industry in that it is more efficient, user-specific, and cost-effective than traditional training methods.

The method and system of the present invention reduces the need to maintain multiple administrators, trainers and physiotherapists. Instead, the system of the present invention provides an automated solution which can provide a decision-based system that guides the users based on the goals they have set, their profile and medical history, as well as results of a fitness test, reaction test, and results from prior workouts.

The present invention also reduces the manual bookkeeping in terms of both managing the gym facility, memberships, fees, equipment, workout programs, registration and slot booking for training. The present invention utilizes interactive tools such as kiosks, display screens, mobile applications and/or network access to the users to facilitate registration and slot booking.

In order to accomplish these objectives, the present invention provides each patron or user an individualized exercise program of specifically sequenced exercises, tailor-made to that individual user. The present invention provides an automated directed workout which guides the user from one exercise to another in a timed fashion, so as to complete a full exercise regimen within an allotted time period. In a particularly preferred embodiment of the present invention, the user performs these exercises in a private setting by moving from booth-to-booth to perform the exercises.

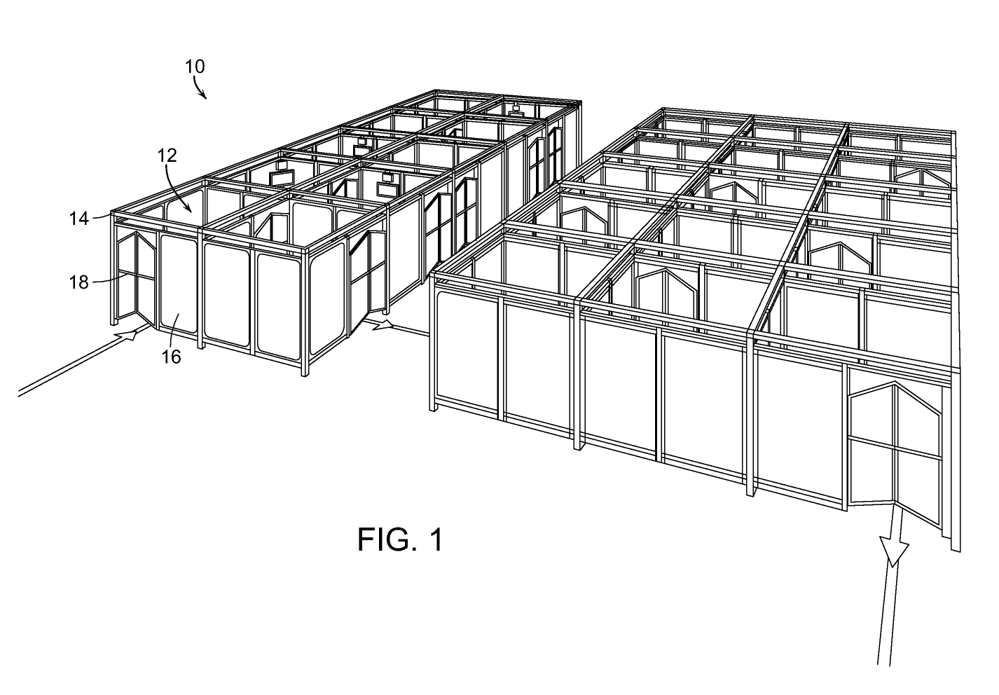

With reference now to FIG. 1, the present invention is directed to a gym or exercise facility 10 having private workout area(s) in the form of booths 12 which are adapted for use by a single user or gym member at a time and which are configured to provide privacy to the user. The booth, for the purposes herein, means any room, divided area, pod, etc. which provides a sufficient degree of privacy and anonymity and space for the member to perform his or her exercise therein. Each booth 12 is assigned an exercise to be performed by a single user or member at a time within the booth 12. Typically, a single exercise device or piece of equipment will be disposed within each booth 12, such that a single member performs an exercise using that device or equipment. It will also be appreciated that the booth 12 can include an exercise mat or the like, for performing an exercise or stretching which does not require an exercise device. The exercise to be performed within the booth 12 and/or the exercise device or piece of exercise equipment can be changed over time in order to accommodate the needs of the invention.

Thus, as illustrated in FIG. 1, a gym is subdivided into a plurality of different and distinct booths 12. Typically, the booths 12 are present within a single room or area of a gym, although it is contemplated by the invention that the booths 12 may fill a portion of a gym structure, the entire gym structure, be placed on more than one level or floor of the gym, or may be divided and in distinct areas of the gym.

With continuing reference to FIG. 1, in a typical embodiment, each booth 12 is formed by a framework 14 which supports a plurality of panels 16, which serve as dividing walls. The dividing walls or panels 16 can be comprised of any suitable material, but are typically semi-transparent or opaque so as to provide privacy and anonymity to the member exercising within that booth 12. Moreover, the panels 16 are of a sufficient height so as to provide privacy and anonymity to the member exercising within the booth 12. Such panels or dividers 16 can be of a predetermined height, such as five to seven feet in height, or extend from the floor to the ceiling, as is deemed desirable or necessary. The dividing panels 16 may not extend to the ceiling, but instead may be of a sufficient height so as to provide privacy to the member while being able to be sufficiently lit from lighting fixtures placed in the ceiling of the gym, which also provides sufficient air flow throughout the plurality of booths 12.

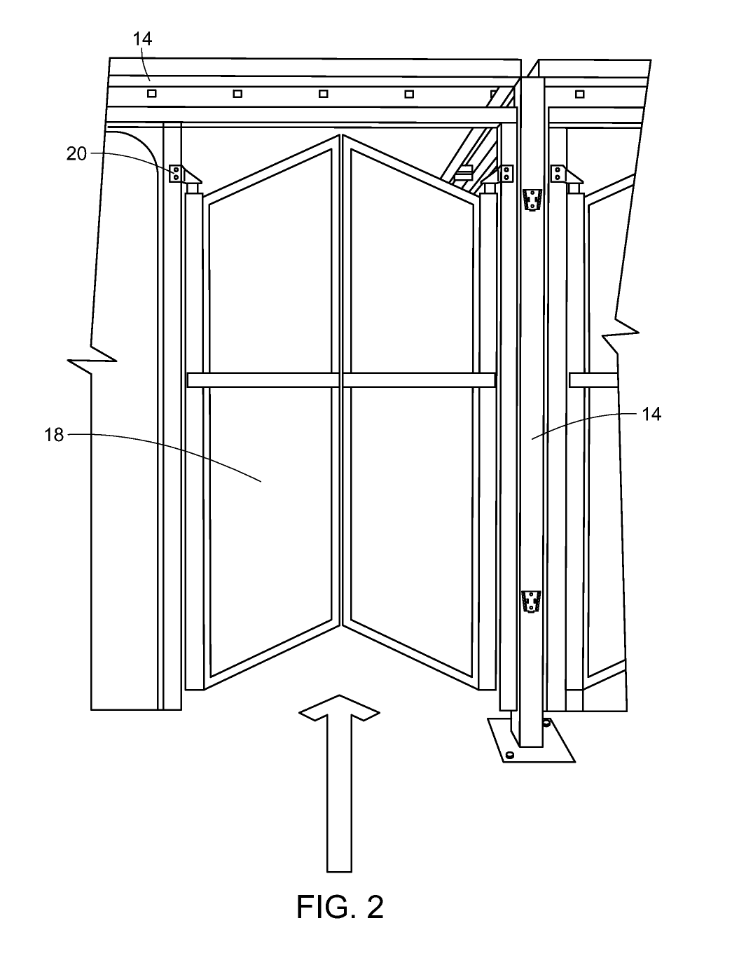

With reference to FIGS. 1 and 2, each booth 12 has at least one door 18 for entry and exit. Each booth 12 may have an entry door 18 as well as an exit door 18, which leads to another adjacent booth, as illustrated. The door 18 may be supported by vertical and horizontal framework members 14. The door 18 may include spring biased members 20 such that the door 18, upon being opened, will automatically close behind the individual entering or exiting from the booth 12. In a particularly preferred embodiment, the booths 12 share dividing walls or panels 16 so as to be immediately adjacent to one another, and so that entry and exit doors 18 are shared between at least a plurality of the booths 12, such that a user or member moves from one adjacent booth 12 to another in a predetermined pathway, as will be more fully explained herein. However, it will also be appreciated that the booths 12 may comprise distinct enclosed areas having their own entry and exit, depending upon the configuration and need of the gym or exercise facility.

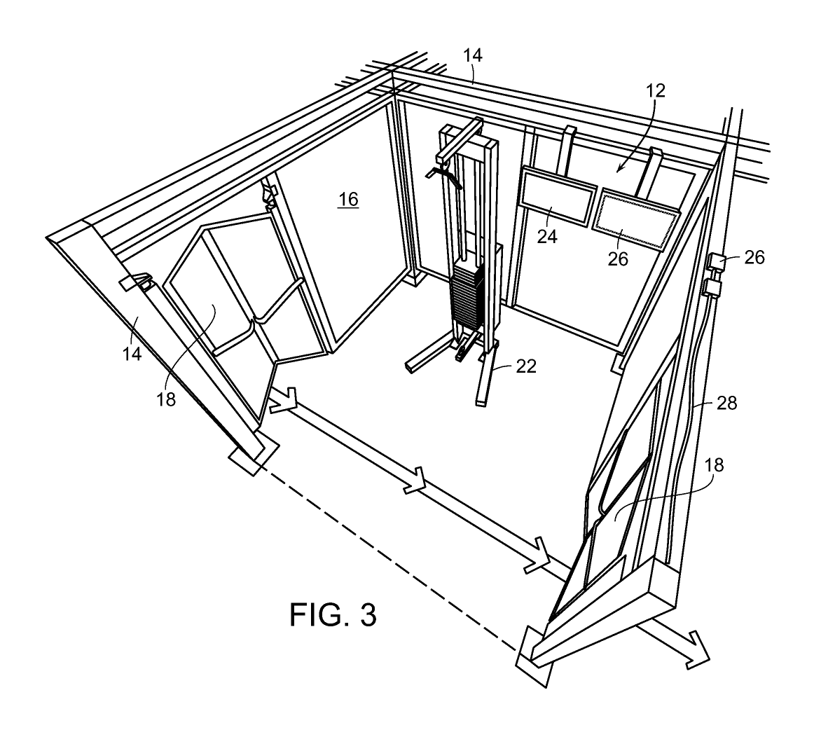

With reference now to FIG. 3, a booth 12 is illustrated with a side wall thereof removed for viewing purposes. It will be seen that the wall panels 16 substantially encompass the booth 12, typically enclosing four sides of the booth 12 so as to make an enclosed room or booth. Doors 18 provide entry and exit points from the booth 12. The panels 16 and doors 18 are mounted on vertical and horizontal framework members 14. As mentioned above, typically each booth 12 includes a single exercise device or piece of machinery 22. In this manner, typically, each booth 12 is used by a single member for a single exercise utilizing the exercise device 22 at any given time. The booths 12 are of a sufficient size so as to accommodate the user, the exercise to be performed, and any exercise device 22 therein to perform the exercise. As such, the booth may be as small as fifteen square feet or as large as two hundred square feet, but more typically between twenty-five and one hundred square feet in size so as to comfortably accommodate the user, any exercise device and the exercise to be performed while still permitting the gym or exercise facility to provide a sufficient number of booths so as to accommodate a sequence of exercises to be performed by the gym member users in accordance with the personal training system and method utilizing the booths in accordance with the invention.

It is believed that the use of individual booths 12 will eliminate distractions which will allow for better concentration and a more effective workout. The privacy and anonymity provided to the member from each booth 12 also eliminates the intimidation or “judge your neighbor” factors which many public gym users dislike, or even are dissuaded from utilizing a public gym for these reasons. Of course, this will take away much stress and anxiety from these individuals working out in a private individual booth 12 setting at each workout station.

Each booth 12 may include at least one electronic device, such as the illustrated display monitor 24 therein. The display monitor 24 is used as an instructional tool to provide the member with a tutorial and guidance on how to perform exercises within the booth 12, such as how to properly utilize the exercise device 22 or perform the desired exercise.

In accordance with the present invention, the time the user spends within each booth performing the exercise within that booth is set. There are a variety of means in which to inform the user of the time remaining to perform the exercise. This may be done audibly, such as announcing a start time, an intermediate time, and a final countdown to end the time within the booth and proceed to the next booth. Alternatively, or additionally, the timer may be displayed, such as on the same electronic display 24 which provides the instructional tutorial. As illustrated in FIG. 3, however, a second electronic display 26 may be provided which provides a visual display of the time remaining to perform the exercises. The timers in each booth will be synchronized with one another, such as by obtaining the time from a common source, so that all of the booths are synchronized with one another and the users within the booths will move from booth-to-booth at the same time, as will be more fully described herein.

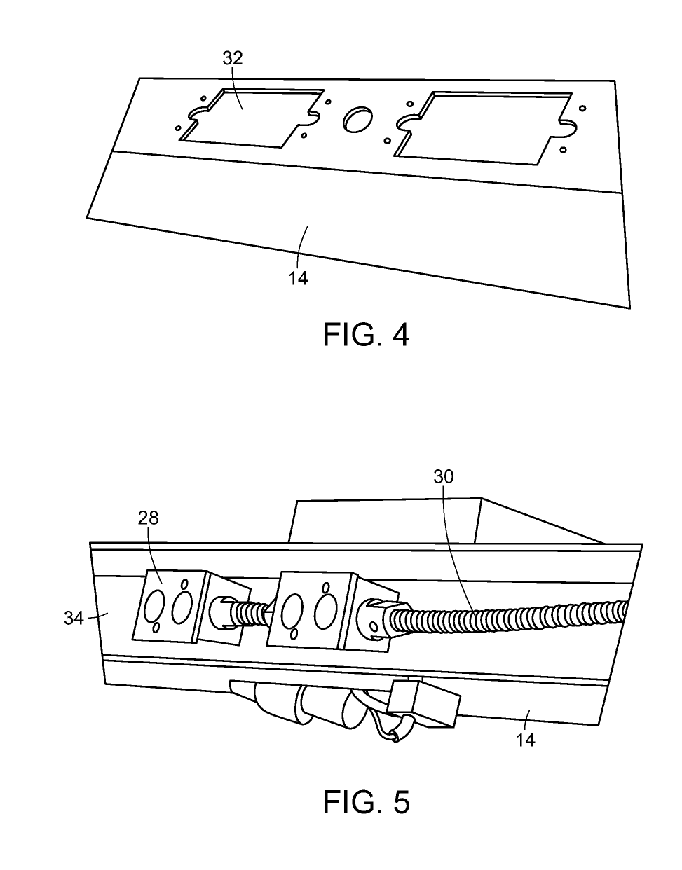

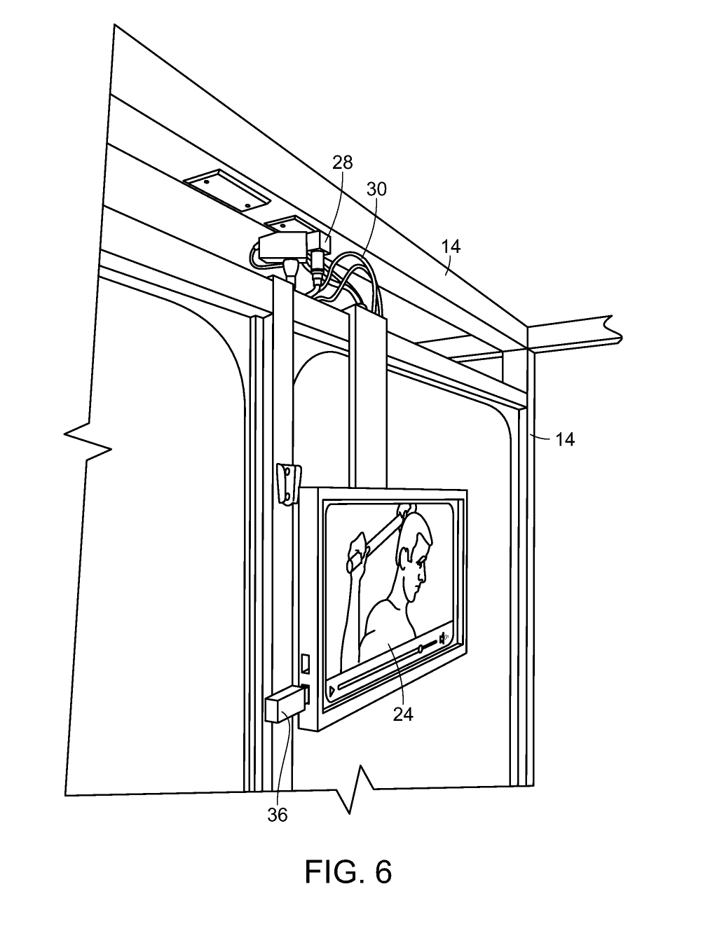

The workout area of the exercise facility or gym includes the necessary electrical outlets and plugs 28 and wiring 30 to provide the necessary electricity, cable and/or Internet cabling and access, etc. Preferably, the frame members 14 are able to accommodate such electrical outlets 28 and wiring 30, such as being channeled or the like. For example, as illustrated in FIGS. 4 and 5, framework members 14 may include pre-punched holes 30 for the insertion and coupling of electrical outlets 28, as needed. FIG. 5 illustrates such electrical outlets 28 disposed within or otherwise coupled to such cutout openings 32 and disposed within a channel 34 of the framework 14. FIG. 6 illustrates a display screen 24, operably coupled to electrical outlet or plug 28, such as by means of wires 30, so as to provide sufficient electricity thereto.

With continuing reference to FIG. 6, the electronic screen or monitor 24, as described above, is used as an instructional tool to provide the member with a tutorial and guidance on how to perform the exercises within the booth and how to properly utilize the exercise device 22. Typically, each exercise booth 12 has a different piece of exercise equipment 22 or a different exercise to be performed therein. While a central computer, such as a server, could track each booth and provide a separate video or animated tutorial to each electronic display 24, this complicates the overall system somewhat and makes it more expensive to install and maintain. Furthermore, issues could arise with the central server computer, or networked computers or dedicated computers within each booth supplying the tutorial information. A problem with even a single booth will affect the remaining booths as the users move in sequence in a timed manner from booth to booth in accordance with the present invention. In order to overcome these potential problems, the present invention contemplates the use of a plug-in device 36, such as a thumb drive, which can be plugged into an outlet, such as an HDMI or USB outlet of the electronic monitor 24. The animated or live video tutorial would then be placed on a continuous loop, so as to repeatedly show how to use the exercise equipment and perform the exercise within that booth. In the event that the sequence of exercises is altered and/or a different piece of exercise equipment is placed in a given booth, the plug-in device 36 having the instructional tutorial could be moved from a display screen 24 in one booth to another booth having that piece of exercise equipment and the exercise to be performed which is shown in the tutorial video saved on the plug-in device 36. This would take but a few moments and would not require complicated reassignment of tutorial videos saved on a server, dedicated computers for each booth, or the like.

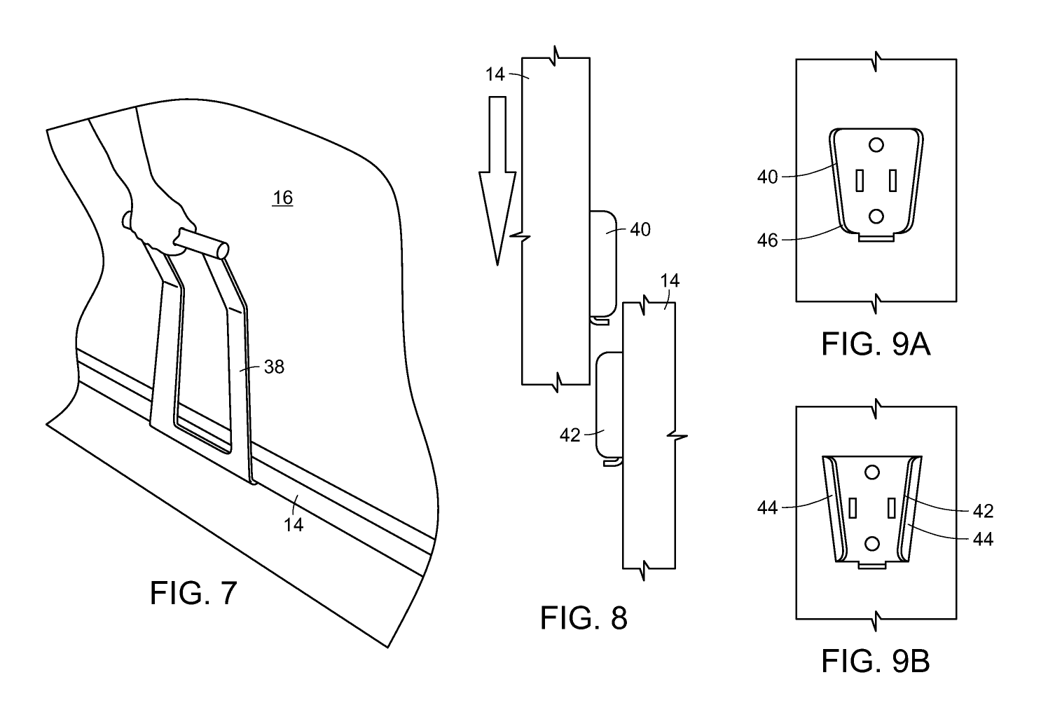

With reference now to FIGS. 7-11, it may be desirable to periodically replace one piece of exercise equipment with another within a given booth 12. This may be due to the previous exercise device or piece of machinery malfunctioning, becoming aged and obsolete, or to alter the exercise provided within that booth. Due to the enclosed nature of the booths, means may be necessary in order to easily and selectively remove one or more panels in order to provide access to the exercise device 22 therein such as when the doors 18 are too small to move the exercise 22 in and out of booth 12.

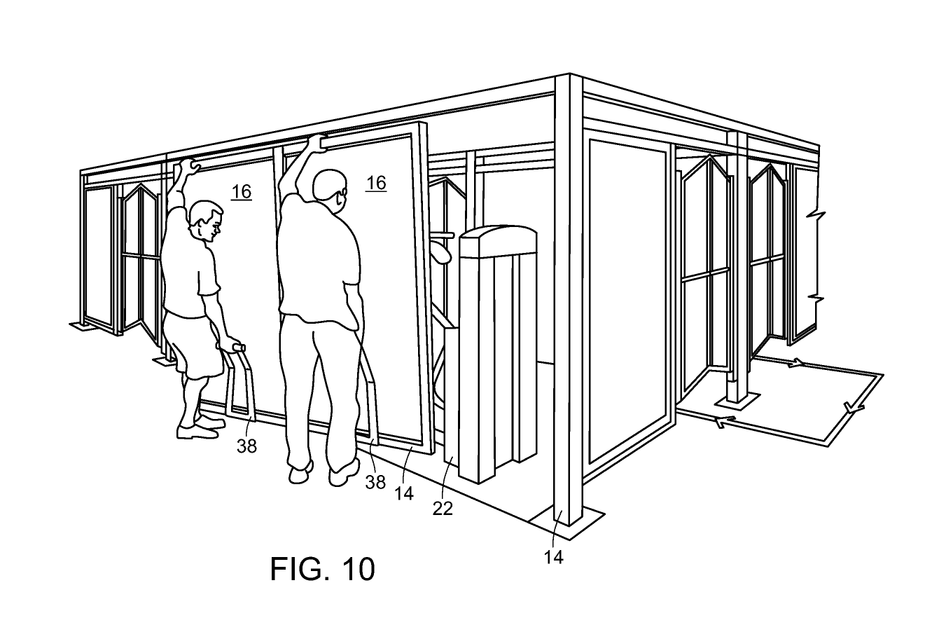

FIG. 7 illustrates a manual lifter tool 38 which can be disposed below a lower edge of the bottom framework 14 so as to lift the panel 16, as illustrated in FIG. 10. This can be done with one or two individuals, as illustrated. The framework 14 of the panels 16, and adjacent framework which is not bolted or otherwise secured to one another, include releasable locking elements 40 and 42, which can serve to lock a panel to an adjacent typically vertical framework 14.

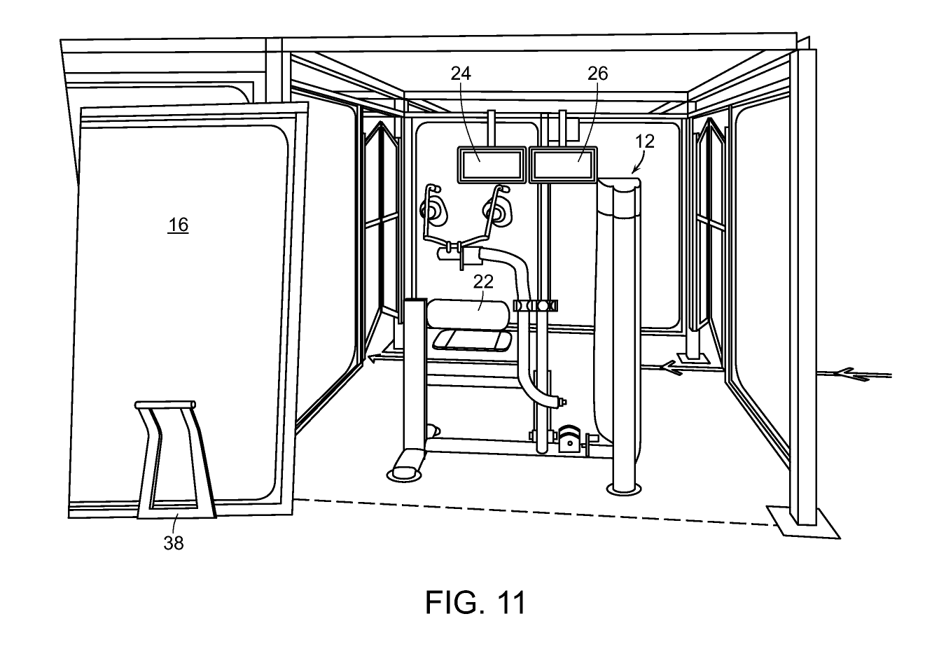

FIGS. 9a and 9b illustrate a male locking element 40 and a female locking element 42 which can be slidably engaged with one another so as to lock adjacent panels and/or frame members 14 to one another. As illustrated in FIG. 8, the male locking element 40 is slid into the receiving portion of the female locking element 42. This can be done, for example, by dropping the male locking element 40 into the receiving female locking element 42, which has wings 44 defining gaps or grooves into which the edges 46 of the male locking element 40 slide into. In order to remove the male locking element 40 from the female locking element 42, and thus the framework or panel attached to the male locking element 40 from the panel or framework attached to the female locking element, the panel or framework having one or more male locking element(s) 40 attached thereto is merely lifted with respect to the other framework or panel having the female locking elements 42, as illustrated in FIGS. 7 and 10. This enables the one or more panels 16 to be removed and set to the side while the interior of the booth 12 is accessed, so as to replace, for example, an exercise device 22 therein, as illustrated in FIGS. 10 and 11.

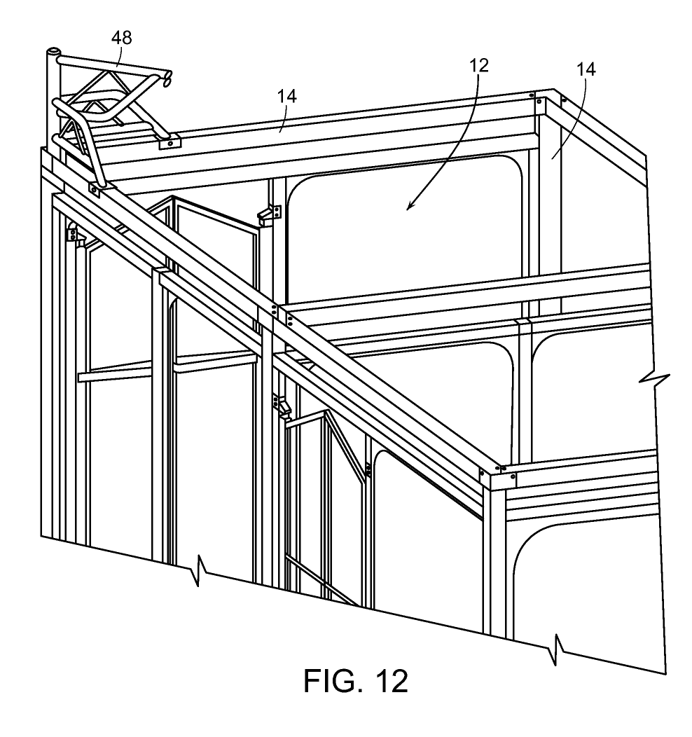

With reference now to FIG. 12, it is contemplated by the present invention that instead of a piece of exercise machinery within the booth 12, an exercise device 48, such as that illustrated in FIG. 12, may be attached to the framework 14 in order to perform the exercise. This can be, for example, a device having a cable and pulley system connected to weights or other resistance for performing lat pull downs, triceps pull downs, or the like. Other such devices are also contemplated.

It will be appreciated that the size of each booth 12 can be uniform, or adjusted in order to accommodate the space requirements for the exercise for that booth 12. For example, a booth 12 having a relatively large piece of exercise equipment can be made with varying size panels or multiple panels in order to accommodate the piece of exercise equipment, or a booth 12 in which a lat or triceps pull down device 48, as illustrated in FIG. 12 will require less space or fewer panels and thus be smaller in size. The interlocking framework 14 of the male and female locking members 40 and 42, and bolts, nuts, or other fastener systems can be used in order to create the desired number of booths 12 and adjust the size of the booths as needed. Typically, the booths 12 are placed adjacent to one another and provide passageway from one to another, as illustrated herein.

It is also contemplated by the present invention that the environment in each booth 12 can be altered to enhance the exercise experience. For example, the booths may have a certain type or degree of lighting which will be conducive to the user. The air can be conditioned to a desired temperature, humidity, or even desirable smells can be placed into the circulated air of each booth. The color scheme and/or design of each booth can also be altered to enhance the user's experience. It is also contemplated by the present invention that speakers could be used to play music for the individual. Of course, the member could also plug in a personal hand-held electronic device to play the member's music within each booth 12 as well.

In a particularly preferred embodiment an exercise regimen with a predetermined exercise sequence is provided to the member. This entails the member typically moving from one booth to another booth to perform a particular exercise within that booth, such as performing an exercise utilizing an exercise device or machine 22 within that booth. This further facilitates the member's experience at the gym by means of the member being directed from booth to booth to perform different exercises in accordance with an assigned exercise program such that the member does not need to concern himself or herself with which exercises to be performed that day or to find a booth or piece of exercise equipment.

In accordance with the present invention, an exercise workout regimen is provided to each member of the gym which is specifically personalized and tailored for that individual, yet consisting of the exercises to be performed in the various booths of the gym. Upon providing information and test results, a personalized workout regimen is provided to each member of the gym.

Each member of the gym, as will be more fully described herein, will schedule a specific session at the gym and begin at an assigned booth number. Each booth will be assigned a particular stretch, warm-up, exercise, or rest period. The individual will proceed from booth to booth, as directed, thus obtaining an optimum workout without having to worry about which exercise to perform next.

The present invention contemplates a full body exercise by varying the exercises to be performed with arm muscle groups, chest and back muscle groups, core muscle groups, and leg muscle groups by performing a sequence of exercises as the user moves from booth to booth. Cardiovascular exercises are also contemplated by the invention. By varying the type and number of exercises, a full body workout can be obtained in a relatively short period of time, such as within thirty minutes.

It is also within the scope of the present invention that a series of booths be specialized so as to create a cardiovascular workout, an upper body workout, a lower body workout, etc. to provide the gym member the flexibility in choosing to focus on these types of exercises. This would entail having multiple series or sequences of booths which are independent of one another. For example, three sets of thirty booths could comprise three sequences, each sequence providing approximately a thirty minute workout. Exemplary exercise programs which can be created by sets of booths and selected by the user or gym member include a general fitness program and calorie burn, or a power performance program. A particular set of booths may have exercise equipment or exercises assigned thereto which are more specific or applicable to a given desired fitness program.

Alternatively, or in addition to, the workout regimen could account for the desired and selected fitness program so as to alter the weight or resistance, number or repetitions or the like of each exercise to be performed. For example, the number of repetitions at a given weight may be increased for a general fitness program, whereas the amount of resistance or weight would be increased but the number of repetitions decreased for a strength enhancing program of a given exercise. The range of weights or resistance for each exercise device within the sequence of booths can be categorized and the user or gym member assigned a weight or resistance category depending upon their input, fitness program selection, and fitness testing results.

In a particularly preferred embodiment, in order to automatically generate a workout regimen for a member of the gym or exercise facility, the general fitness level of the member is determined. In accordance with an embodiment of the invention, the user may take a single fitness test. In a particularly preferred embodiment, this comprises a strength test, such as a grip strength test using a hand dynamometer. This determines the strength of the individual, and it has been found that there is a strong correlation between this test and total body strength. Although the use of a grip strength test is particularly preferred, it will be appreciated by those skilled in the art that other fitness tests or strength tests can be used in its place. The strength test replaces the need to do a maximum test on every single piece of exercise equipment in order to calculate how much weight or resistance should be used in those exercises by the user. The computerized system of the present invention utilizes algorithms associated with the fitness strength test so as to calculate a baseline fitness and strength level of the member without having to do so many tests. Moreover, the results of the strength test set a baseline of weight and repetitions for that individual for each particular exercise to be performed.

Alternatively, the user may perform a single repetition of an exercise at a given resistance or weight and adjust the resistance or weight upwardly or downwardly based upon a determination of an ability to complete the assigned number of repetitions. The assigned number of repetitions varies according to the user's age, sex, and fitness program selected. The user should be able to accomplish the goal-number of repetitions within the time allotted for the exercise within the booth. However, in order to maximize the benefit of the exercise to the user, the user should experience some difficulty in performing the final repetitions of the exercise. If the user, upon performing a single repetition at a given weight or weight category or resistance believes that he or she will be able to easily perform the number of repetitions within the allotted time or even more than the assigned number of repetitions within the allotted time, the user should increase the weight and/or move into a different weight category. However, if the user upon performing a single repetition of the exercise at a given weight does not believe that he or she can accomplish all of the goal-number of repetitions within the assigned time period, the user should attempt the repetition at a lower weight or resistance so as to be properly classified and categorized.

The entire range of weights or resistance for a particular exercise device is broken up into categories, which are labeled with indicia or color. Typically, each category or classification of weight or resistance includes more than one weight or resistance, such that the user can increase or decrease somewhat the weight within the category assigned to him or her depending upon how that user feels that particular day while exercising.

In accordance with the present invention, a patron or member of a gym incorporating the system of the present invention, or, in other words a user of the method and system of the present invention, may also complete a health history and physical trait questionnaire. The user may provide user-related information including the user's age, gender, weight, height, physical limitations or other health concerns, and the like. This may be done online or when the user first attends the gym incorporating the present invention.

For example, a young six foot two inch, two hundred twenty pound male having high strength and no health history concerns interested in improving his strength will be given a different workout regimen than another male who weighs three hundred pounds and is interested in weight management, or a five foot three inch, one hundred pound female of advanced age who is interested in general fitness. This can be accomplished even if the equipment or workout stations are the same and the time interval of exercising at each station is the same.

The workout program consists of a given number of exercises performed over a given period of time. These exercises typically involve a piece of exercise equipment or machine but can involve a manual exercise, such as sit-ups, push-ups or the like assigned to some of the booths 12. Each exercise is timed and the user performs the number of assigned repetitions of the exercise performed at the predetermined resistance. The user will then move to another exercise station within another booth, such as a piece of equipment or machine in which the user is to curl a given amount of weight for a given number of repetitions.

Over time, as the individual gains strength and/or improves his or her fitness level, the exercise regimen for that individual may be altered, such as the user increasing resistance to stay within a desired repetition category, so as to continue to challenge the individual and increase his or her strength, fitness level, weight management, etc. It should be understood that the user may not be assigned a specific number of repetitions to be performed, but rather a range of repetitions. For example, when selecting the performance or increased power program, the user will be assigned to perform between six and eight repetitions. For overall strength increase and hypertrophy, or increasing lean muscle mass, the user may be assigned to perform between nine to eleven repetitions at the assigned weight category. For general life fitness and caloric burn, at least twelve repetitions may be assigned. Over time as the individual gains strength and/or improves his or her fitness level, the number of repetitions may increase. However, if they are still within the range prescribed, the user may elect to maintain the weight category or resistance level assigned, and only increase to the next category of weight or resistance when the user can comfortably perform the desired number of repetitions at that weight or resistance. As mentioned above, optimally, the user will experience an increasing challenge to perform the goal-number of repetitions, almost to muscle failure at the last repetition performed.

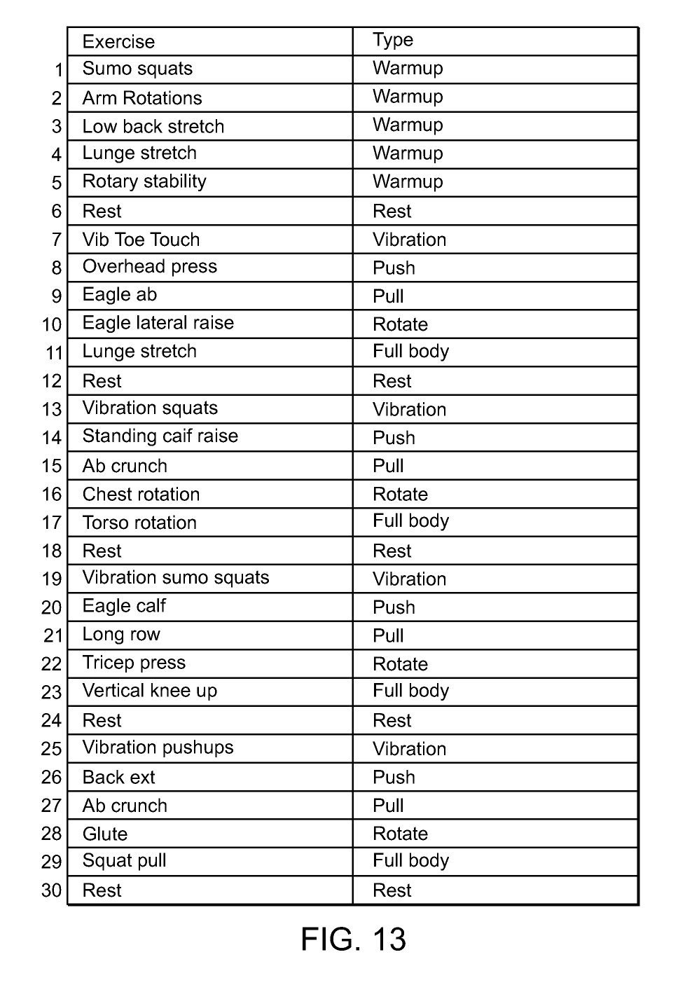

With reference now to FIG. 13, an exemplary exercise regimen of exercises that could be presented to a registered user and incorporated into the present invention is shown. As can be seen from a review of FIG. 13, the exercise regimen includes initial warm-up and stretching exercises, followed by a vibration exercise performed via an exercise device which provides vibration to the user, a push exercise wherein the user will use his or her arms or legs to push, a pull exercise, a rotate exercise, and a full body exercise interspersed with rest periods. The general exercise regimen illustrated in FIG. 13 does not include the weight or resistance to be used by the user or a suggested number of repetitions, or a time in which to complete the exercise. The target weight or resistance to be used by the user and the target number of repetitions will be provided in the user's personalized exercise regimen. Typically, the user is provided a set period of time within each booth to complete the exercise, such as between thirty seconds and two minutes. Thus, the exercise regimen illustrated in FIG. 13 could be completed in between twenty and sixty minutes and provides the user a complete full body workout.

It is to be understood that the exercise regimen illustrated in FIG. 13 is for exemplary purposes only. While providing a full body workout within a predetermined amount of time, the exercise regimen may be changed to suit the needs of the user, the needs of the exercise facility, etc. It will also be understood that if the sequence of a warm-up, vibration push, pull, rotate, full body exercises separated with rest periods are to be followed, as indicated in the right-hand column of FIG. 13, the warm-ups, stretches and exercises corresponding to these in the left-hand column can be changed. It will also be understood that some of the exercises may be performed without any exercise device or machine whatsoever, and instead only require a sufficient amount of space and possibly a mat or the like. However, other exercises may require the use of an exercise device or machine, and the machine may be of the type that the user can perform multiple, different exercises as the user rotates through the booths in order to complete the exercise regimen.

In accordance with a particularly preferred embodiment of the invention, the sequence of exercises provided in FIG. 13 would be performed in a plurality of booths. The user or gym member would move from booth to booth to perform the different warm-up, rest and exercises. The necessary exercise devices and equipment to perform the exercises within the sequence would be provided within the booths. It will be appreciated that the exercises and sequence of exercises provided in FIG. 13 are illustrative only. Different types of exercises or sequences of exercises could also be implemented into the present invention. What is desired is that the user is provided a workout sequence of exercises the user performs in order, moving from booth to booth to perform the exercises. The workout regimen dictates the exercise to be performed, the weight or resistance, and the goal number of repetitions of the exercise within an allotted time period. As such, the user is provided a workout regimen of a sequence of exercises that accomplish the fitness program goal of the user in a very scientific and effective manner with minimal thought and input from the user.

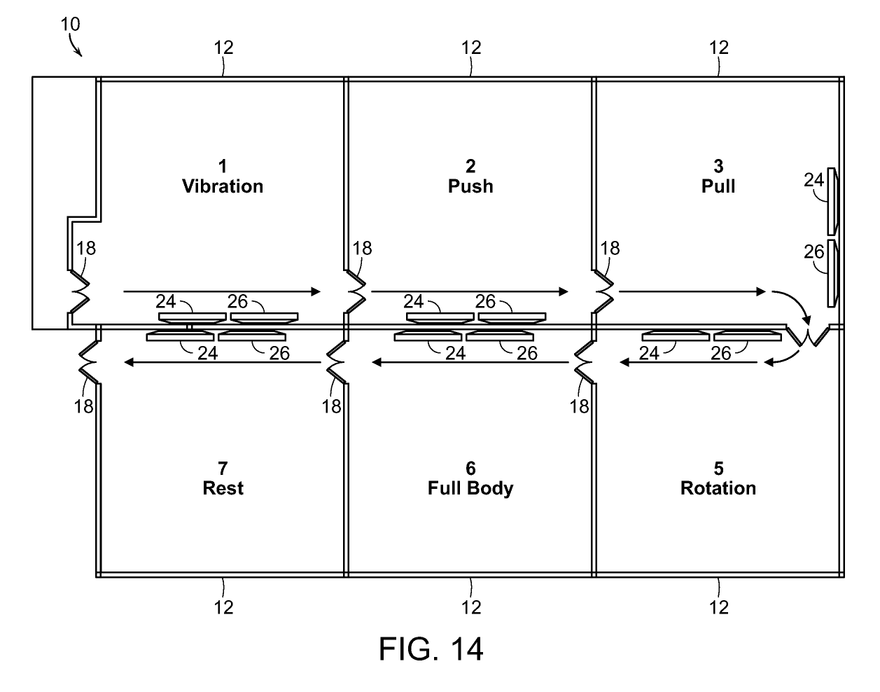

The exercise program discussed above is particularly suited for the private gym configuration and system having a workout area defined by a plurality of booths, as illustrated and described above. For example, with reference to FIG. 14, a gym or a section of a gym having only six booths 12 could be used to perform the preset sequence of exercises, with the user continuing to rotate through the booths 12 until the desired number of exercises or total exercise time has been achieved. With reference again to FIG. 14, it will be seen that a display screen 24 is positioned within each booth 12. The display 24 will display the workout to be performed by the member. Typically, the exercise is timed such that the member will attempt to perform the number of repetitions given by the system within the allotted time. The timer may be displayed on electronic screen 26.

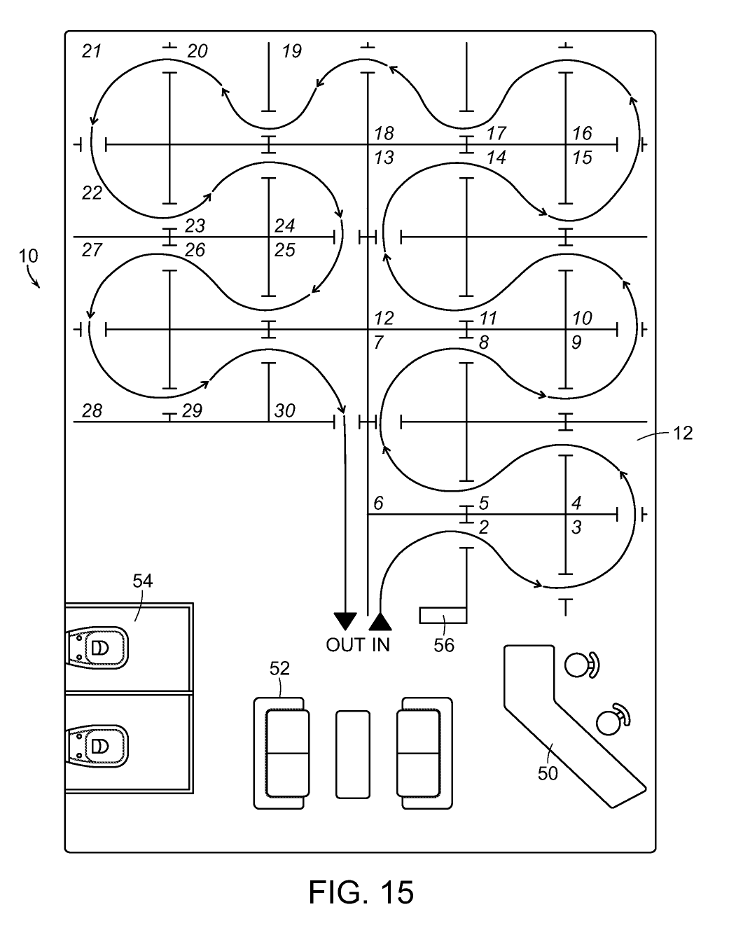

With reference now to FIG. 15, although the gym could have fewer booths repeatedly used to accomplish the exercise regimen, such as five booths, in a more particularly preferred embodiment of the present invention, the gym 10 has a sufficient number of booths that an entire workout regimen can be performed by moving from one booth to another only once until the entire exercise regimen sequence is achieved.

The gym 10 will typically have a reception desk 50 with employees available to register the member, assist the member in beginning the workout, etc. A waiting room 52 and restrooms 54 will typically be provided. A kiosk or display monitor or the like 56 may be provided, such as outside the initial booth, for the member to log in and/or be prompted to enter the first booth. The member then proceeds through the various booths 12 (numbered 1-30 in FIG. 15), performing a different exercise or a rest period. In the case of providing one minute of time to perform the exercises or rest within each booth 12, in the arrangement illustrated in FIG. 15, the member's workout would last thirty minutes.

Although only one member would be in a given booth 12 at any given time, it will be appreciated that multiple members could be exercising within the booths and the gym at the same time, but be present in different booths so as to follow the sequence of other members. In the arrangement illustrated in FIG. 15, with a total of thirty booths, up to thirty gym members could be present and performing their exercises according to their individualized workout regimens at any given time. Of course, when the first member left the last booth, another member could enter into the first booth to begin his or her workout regimen.

The system of the present invention allows members to schedule a specific time to begin their workout, and then moves that member from the first booth through each of the series of booths until the workout session is completed. It will be appreciated that each booth at any given moment may have a different member of the gym therein performing an exercise. All of the exercises are specifically timed, such that each gym member in a given sequence or series of booths finishes his or her exercise for that specific booth at the same time, and is provided an allotted amount of time to move to the next booth, such that gym members are moving from one booth to another at approximately the same time, such that there is only a single member within a booth at a given time.

It will be appreciated that each booth 12 includes a workout station, which can comprise a mat for performing stretches or manual exercises, such as sit-ups, push-ups, etc. However, an exercise device or piece of machinery is disposed within at least a plurality of booths, if not all booths, for performing a particular exercise. Typically, only a single piece of exercise equipment or machine is in each booth, such that the user performs only a single exercise, according to the repetition and resistance/weight provided by the personalized exercise regimen.

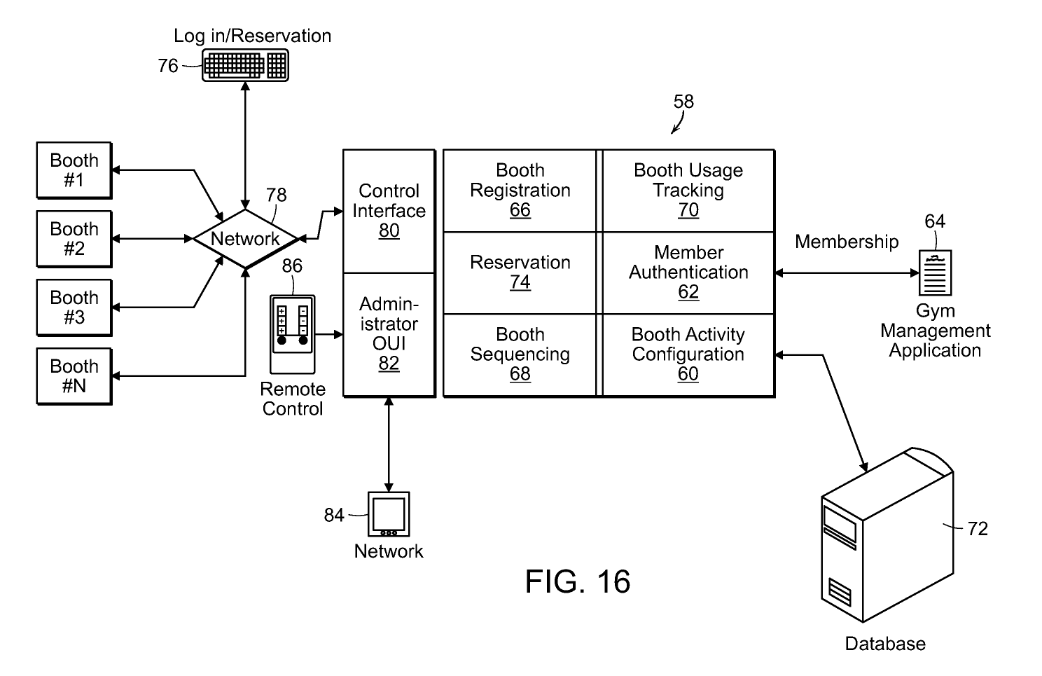

With reference now to FIG. 16, an electronic framework of the computerized system utilized in accordance with the present invention is illustrated. This includes the booth application server 58, which may represent a central computer for each gym or location. It is also to be understood that the server 58 could represent additional servers or computers which are connected to the computers, or otherwise receive the information, from the individual gym locations. Clients or users access the server or computers from access channels such as the interactive kiosks or screens within the common areas of the facility, via the user's computer and an Internet network connection, or via mobile application or the like.

The server 58 may include a booth activity configuration module or algorithm 60, which allows the administrator to define the activity for each of the booths and also have relevant information like video or audio tagged to such activities which can be rendered to the user on the display 24 while he is performing the workout. Authentication module 62 performs member identification, number, card swipe, electronic chip reading, etc. by interfacing with a third-party gym management software 64.

The server 58 has a variety of configurations and purposes. These include a booth registration 66, wherein a particular booth is registered and mapped to a certain exercise activity. The system has the ability to define the booth setup procedure followed by initialization and sequencing 68 process where the booth number shall be entered and submitted by the administrator.

The server also verifies and authenticates the user 62 by validating the entered member identification and/or password prior to the start of the booth usage. This may be done with a third-party gym management application software 64, as illustrated in FIG. 16.

The server tracks the booth activity configuration 60. Each activity or exercise that is offered at the facility such as bench press, push-ups, curls, etc. needs to be defined in the system and should be mapped to the respective booth. The server can accommodate any number of booths, such as booths 1-90, and map each one to an activity where the activity need not be a unique entity. For example, the activity called “bench press” may be mapped to both booth number 1 as well as booth number 18, or later changed from booth number 1 to booth number 7. The booth activity configuration tracks the booth number, the activity type, the benefits of the activity, and the video and/or audio feeds that are tagged to this workout or booth. Booth sequencing 68 can be used to sequence the booths.

The server also tracks booth usage 70. An individual should be authenticated at the kiosk or booth for member identification and only after successful identification will he or she be able to proceed further. A typical process flow to the booth usage tracking is that the member arrives at the facility for his or her regular workout regime. The member arrives at the kiosk or booth where he or she will be prompted to validate his or her identity by entering the member identification. The booth will then prompt the user to start the activity defined as part of booth number 1 and also display the time in which he will need to complete the activity. On completion of the defined time for the booth number 1 activity, the user may have a defined time gap to move from one booth to the next, which time may be displayed on the countdown timer of the screen. The user shall then move to the next booth and continue the defined activity and continue this process until the user completes all of the booths for that particular day. It will be appreciated that all members of the gym within the booths are working out in a similar fashion and are timed in sequence through the booths in a coordinated manner.

Although rest periods may be built into the exercise regimen, a rest period is not necessarily essential. The computer algorithms of the system can be changed periodically as new data and information on exercise science is advanced. Each gym's computerized system may be in communication with a central server or a server based in the cloud which can dictate the changes to the workout regimens, exercises to be performed throughout the sequence of booths, etc. Preferably, a member's data and exercise regimens are also stored on a cloud-based or central server, such that the member could visit other gym locations and obtain their exact data and up-to-date workout regimen at any of the gym facilities incorporating the present invention.

As will be described herein, the server includes or is coupled to a database 72 which contains the member's registration information and periodically updated workout regimens. A reservation module 74 allows the members to reserve a time to begin exercising at the gym. The log in reservation 76 may be done at the gym, or away from the gym, such as at home using the member's computer, or even by means of a smart phone or hand-held electronic device. The user logs in to a network 78 which interfaces with the server 58. An interface 80 is provided between the network 78 and the log in/reservation means 76. An administrator may be provided an interface 82 as well, such as via network 84. This may be done by remote control 86 or at the gym. In the event that data is supplied from the central computer or server to the individual booths, such as a synchronized timer or in the event that the particular exercise facility controls the video exercise tutorials through a central computer, this information is relayed via network 78 to the individual booths. However, more typically, the plug-in device described above is used to provide a loop of instructional video and the timers are synchronized with one another by obtaining their timer data from a single source, such as a video player on a continuous loop which feeds the same timer video and/or audio to all of the individual timers within the various booths of the exercise facility.

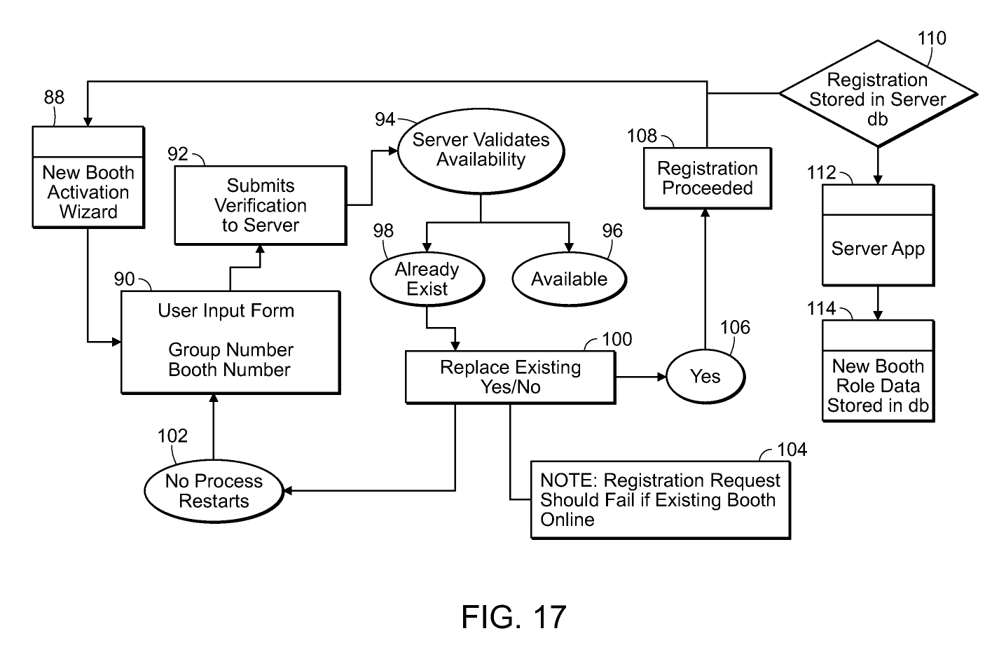

With reference to FIG. 17, software is used in accordance with the present invention to initialize new booths and the booth configuration. The new booth activation wizard 88 receives a user input form providing the group number and the booth number 90. Verification is sent to the server 92. The server validates the availability of the booth 94, and indicates if the new booth is available 96, or is already in existence 98. If it is already in existence, an inquiry is provided asking whether to replace the existing booth 100. If no, the process restarts 102. If the new booth registration request is being conducted while the booth is online and being used 104, registration cannot be completed. However, if this is not the case, and if the administrator desires to replace the existing booth 106, the registration process is started 108, and the registration is stored in the server database 110. The relevant server application software 112, after which the new booth roll data is stored in the database 114.

Thus, in accordance with the method shown in FIG. 17, a new booth can be added to an existing series of booths, or a booth can be reassigned a piece of exercise equipment or an exercise, and tracked within the server and system in accordance with the method of FIG. 17, such that the computerized system can coordinate the sequence of the user's personalized exercise regimens with the exercises and exercise devices assigned to the booths.

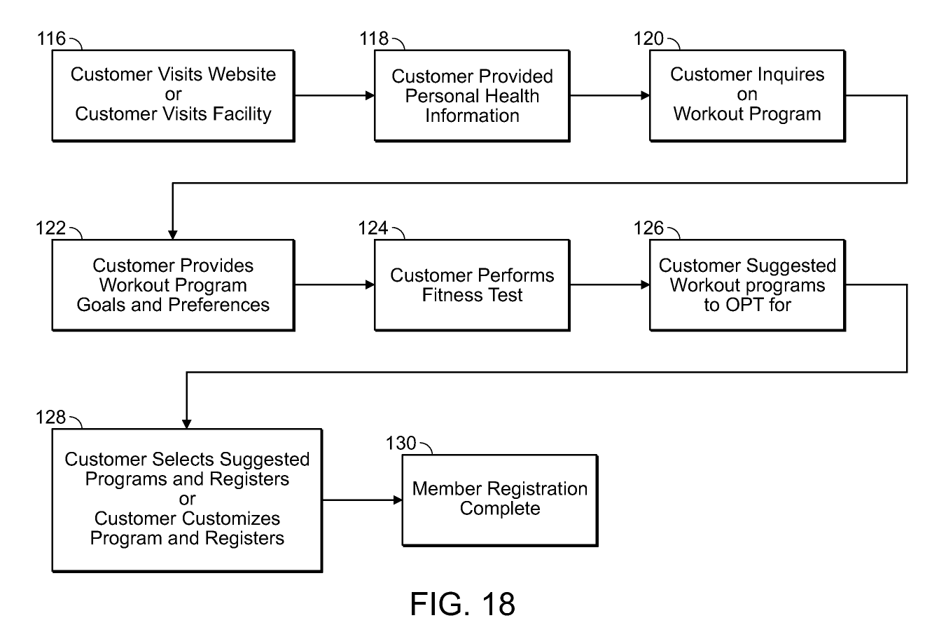

With reference now to FIG. 18, the steps undertaken in registering a member are shown. The customer visits the website or visits the gym facility 116. The customer provides personal health information 118. The customer inquires regarding the workout program 120 and provides workout program goals and preferences 122. For example, the member or user may select a desired fitness program, such as a general fitness and caloric burn program, a strength enhancing program or a performance power program. The customer then performs the fitness test 124, such as the grip test, which is performed at the gym facility. Alternatively, the present invention, as described above, contemplates the potential member performing a reaction-decision test by performing a single “decision” repetition, wherein the member estimates how many repetitions could be done at that weight or resistance level for a given exercise within a certain prescribed time period. This may be done for a single exercise device or exercise, or may be done for all of the exercise devices or exercises which are anticipated to be performed in the sequence of the exercise facility. A suggested workout program is provided to the customer to opt into 126. Based upon the foregoing information provided by the user and the fitness test results and the selected fitness program, a recommended weight or resistance category and a goal-number of repetitions is suggested or assigned to the member. Generally speaking, a selection of a general fitness and caloric burn fitness program will be assigned a goal-number of repetitions between 12-15 or more, whereas if the member has selected a performance power fitness program the goal-number of repetitions may only be eight or nine. The suggested or assigned weight or resistance category, such as green, yellow, orange, red, or the like representing increased ranges of weights or resistance depends upon the results of the user's fitness test. The customer selects one of the suggested programs and registers, or customizes a program and registers 130, which completes member registration 130.

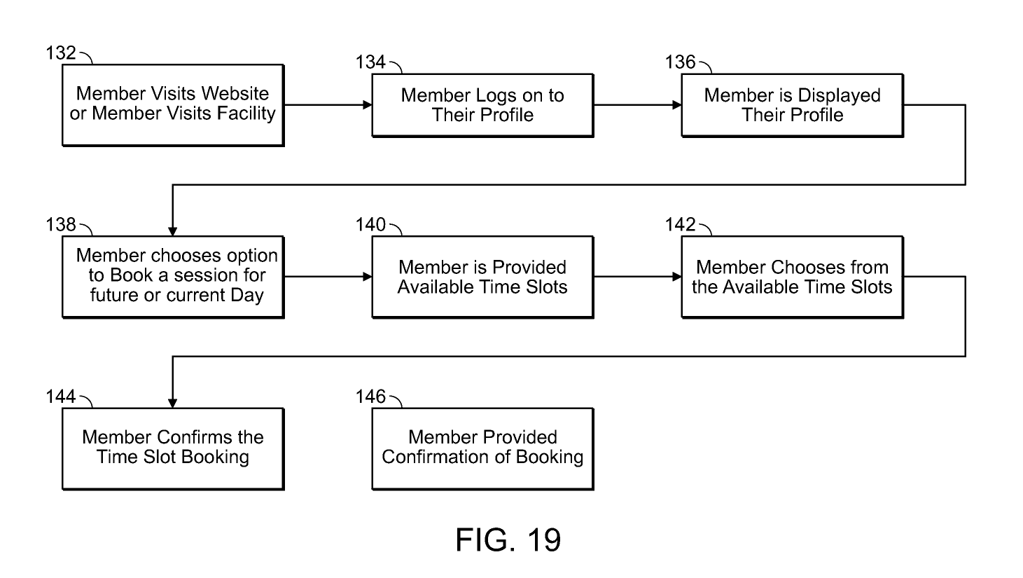

With reference now to FIG. 19, the steps undertaken to reserve gym time is shown. The member visits the website or gym facility 132. The member logs onto their profile which was provided during the registration process 134. The member is displayed their profile 136, and chooses an option to book a session for a future or current day 138. The member is provided available time slots 140 to begin his or her workout. The member chooses from the available time slots 142. The member then confirms the time slot for booking 144, and the member is provided confirmation of the booking 146.

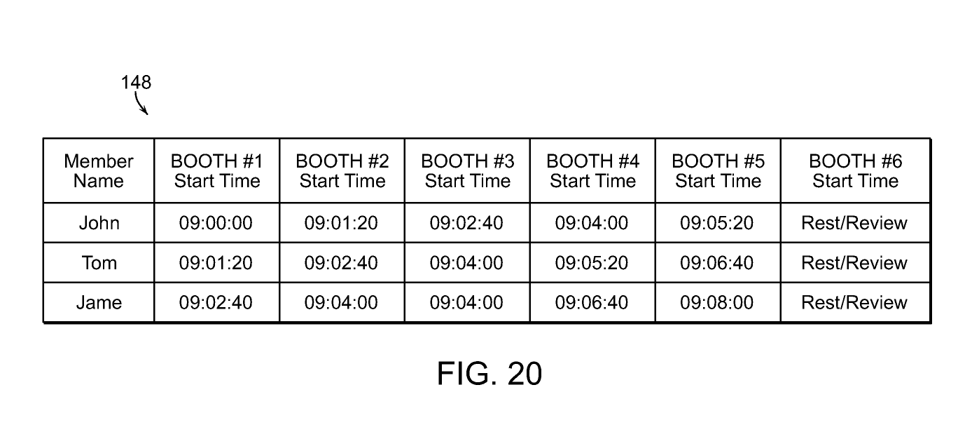

FIG. 20 illustrates a table 148 with exemplary members who have reserved and booked time slots. In the example provided in FIG. 20, members John, Tom and Jane start at booth 1 at 9:00 am, 9:01:20, and 9:02:40, respectively, thus being spaced from one another by one minute and twenty seconds. Assuming that the member is in each booth for a total time of one minute, this would provide twenty seconds for each member to move to the next booth after their exercise is completed in that booth. Of course, the actual amount of time provided in each booth can vary. For example, users or members of the exercise facility may only have one minute to perform the exercise and move to the next booth to perform the next exercise in the sequence of the exercise regimen. In accordance with the preferred embodiment of the invention, the users or members of the exercise facility are only in a given booth performing an exercise for a relatively short period of time so that the entire exercise sequence of the exercise regimen can be performed within approximately twenty minutes to one hour. Within that time frame, the user will have moved to a plurality of booths, spending only approximately a minute or two performing a particular exercise within each booth. However, in order to ensure a smooth flow and operation of the exercise facility, users or members of the exercise facility can register their start time and reserve the first booth, and thus by extension the remaining booths. Otherwise, the user must wait until the first booth in a given sequence is available to enter the booth and begin the exercise regimen and sequence of booths.

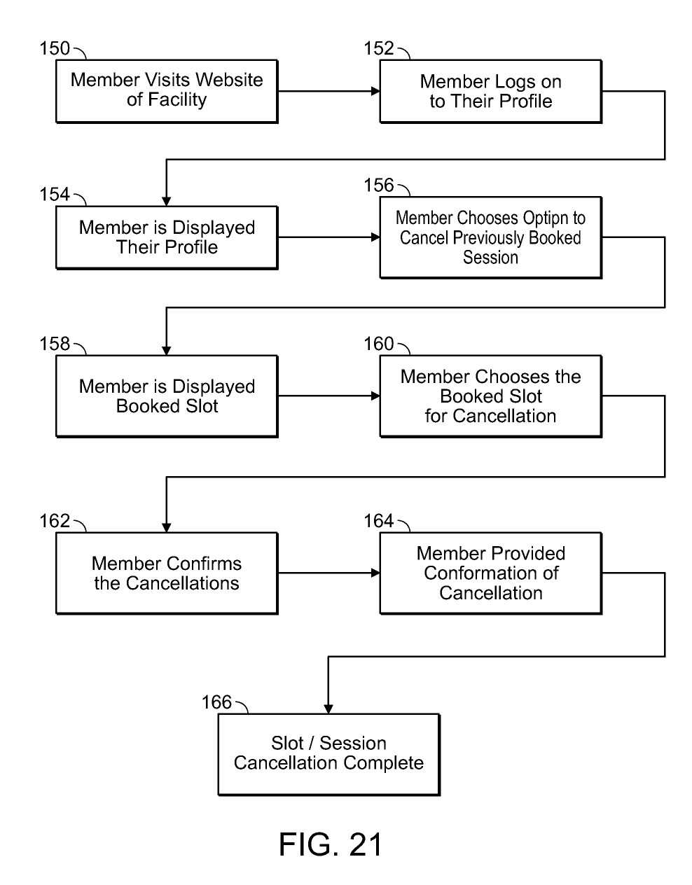

With reference now to FIG. 21, in order to cancel a previously-booked time slot, the member visits the website or gym facility 150. The member logs on to their profile 152 and after being displayed their profile 154, chooses the option to cancel a previously-booked session 156. The member is displayed the booked slot 158, and chooses the booked slot for cancellation 160. The member confirms the cancellation 162, and is provided a confirmation of the cancellation 164. The slot or session cancellation is then completed, and the slot or session is made available by the system to other gym members.

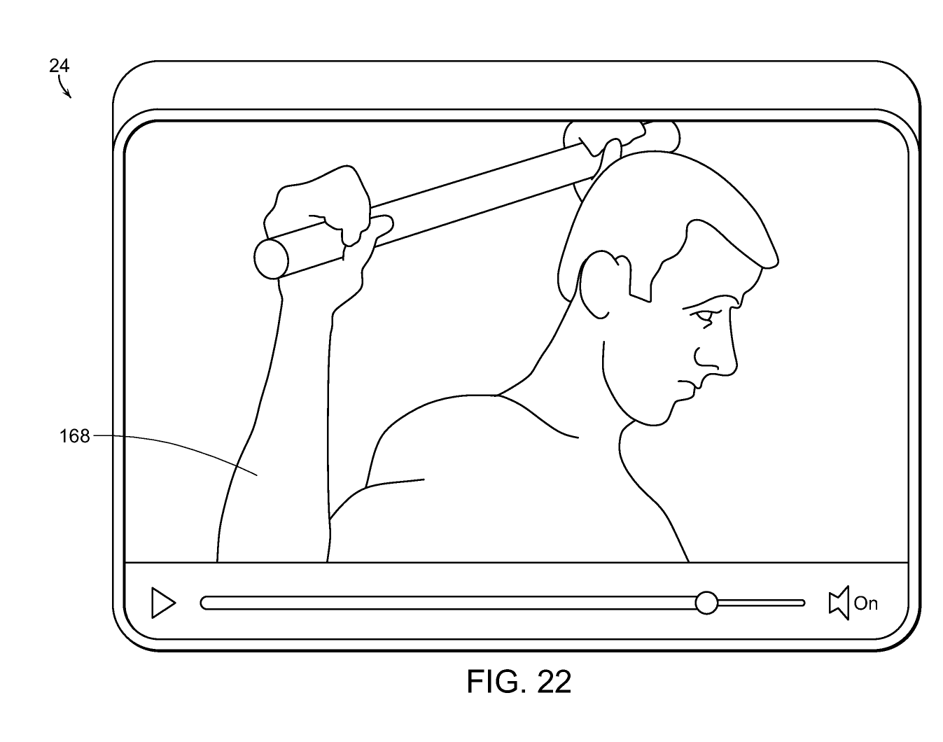

With reference to FIG. 22, upon entering each booth, the display screen 24 displays a tutorial video 168 to show the member how to perform the exercises, and if necessary how to operate the exercise device and/or machine to perform the exercises. The tutorial video 168 may be a series of photographs on how to operate the exercise equipment and perform the exercise within the booth, a video of an individual operating the exercise equipment and performing the exercise assigned to that booth, or an animated video of the same. The tutorial video 168 may also include audio and/or written instructions and prompts. As mentioned above, in a particularly preferred embodiment, the tutorial video 168 is on a loop so as to be repeated over and over again throughout the course of the day such that as each user or member enters into the booth the user or member is able to quickly and easily see how to use the exercise equipment and perform the exercise assigned to that booth.

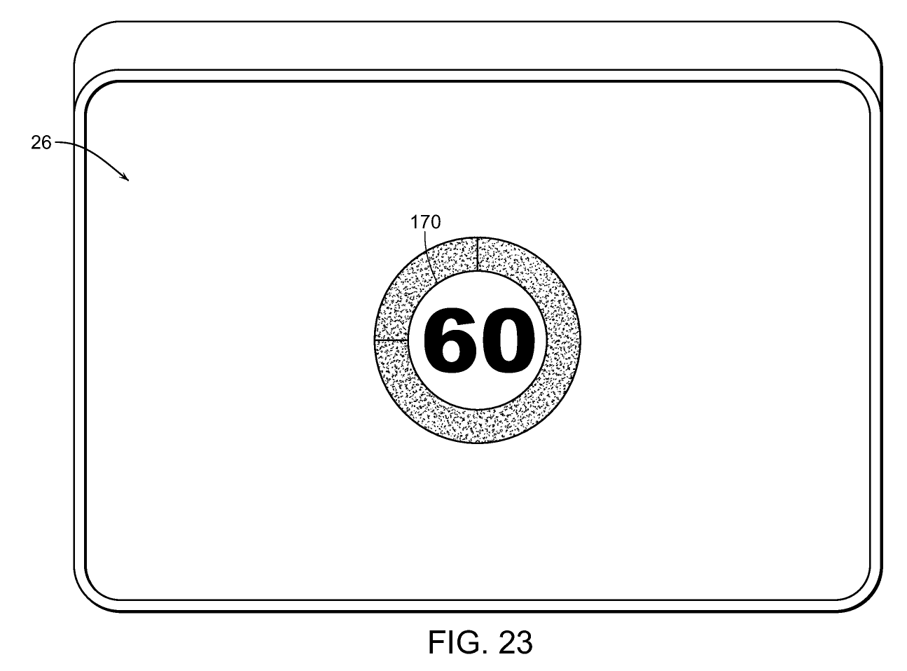

As illustrated in FIG. 23, a timer 170 is also provided, such as via the second electronic display screen 26, so that the user knows the allotted time to perform the goal-number of repetitions of the exercise within that booth, and visually and/or audibly be alerted to the time remaining as the user performs the exercise within the booth. The timer 170 in FIG. 23 is shown as having sixty seconds, although it will be appreciated that the number of seconds can vary. The timer 170 will automatically begin counting, either upwardly or downwardly, so that all of the booths are synchronized with one another. Instead of showing a number representing the number of seconds remaining or lapsed, other timers may be provided such as graphical timers to show the lapsed amount of time or the time remaining to perform the exercise.

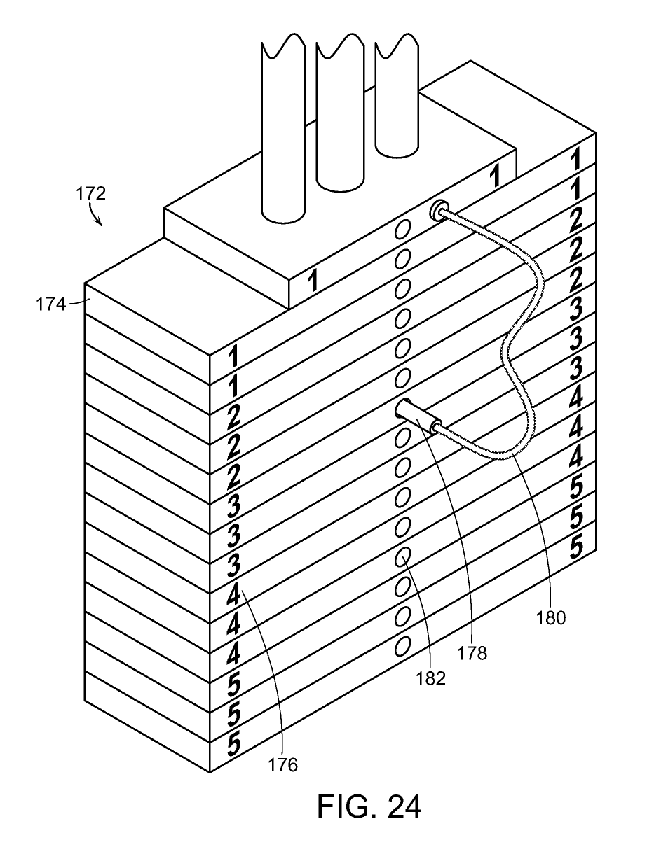

With reference now to FIG. 24, an exemplary set of plates of weights 172 is illustrated, which is commonly used with many exercise devices. Each individual plate of weight 174 of the weight stack 172 represents a given amount of weight, such as five or ten pounds or the like. The entirety of the weight stack 172 is the complete range of weight or resistance for that particular exercise device. It can be seen in FIG. 24 that indicia 176 are associated with the weight stack 172 so as to label and categorize the predetermined weight classifications or categories. In this case, numerals 1, 2, 3, 4 and 5 represent five classifications or categories of ranges of weight within the entire range of weight of the weight stack 172. This effectively divides the entire weight or resistance range of the exercise device into multiple categories. While numerals are used for exemplary purposes in FIG. 24, it will also be appreciated that other indicia could be used, such as letters, colors, etc. For example, several plates 174 of the weight stack 172 could be labeled with the color green, several weight plates 174 of a higher weight could be color-coded yellow, several other additional weights of a higher total weight or resistance could be color-coded orange, etc.

It will be seen in FIG. 24 that the categories do not correspond directly with the weight or resistance of the exercise device, in that three plates 174 of weight are labeled with reference number “1”, etc. This can be advantageously used to enable the user or member of the facility to increase or decrease the weight or resistance in a given category depending upon how they feel that day. If they are tired or sick, the user may select the lowest weight or resistance within their assigned category, or in some cases may even lower the weight or resistance to a lower category than that assigned to them. However, on a day when the user feels refreshed and strong, the user may select the highest weight or resistance within their assigned category. Of course, over time, as the user's strength and fitness level increases, the user may move upward to a higher weight or resistance category and be able to perform the goal-number of repetitions within the prescribed period of time.

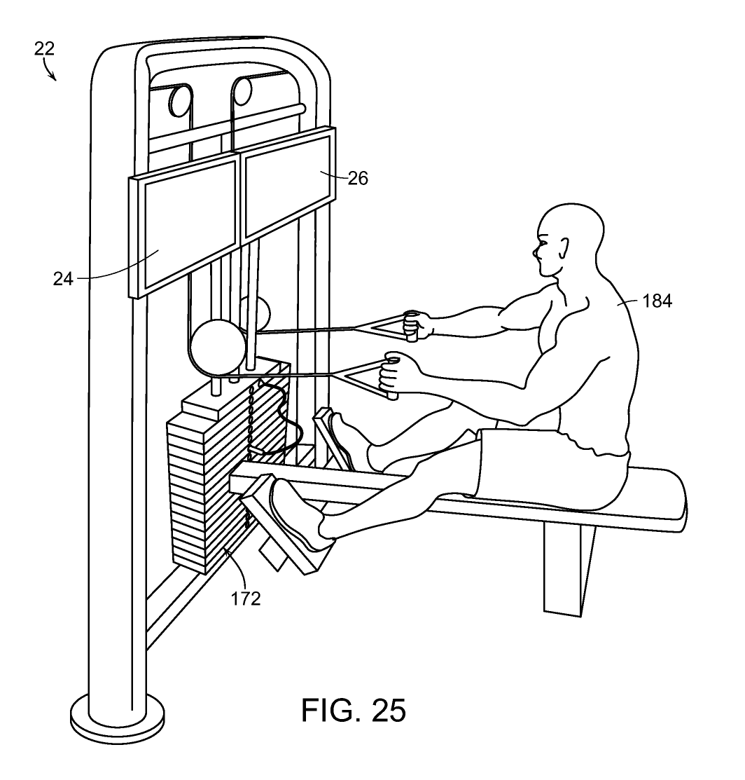

With continuing reference to FIG. 24, in order to begin the exercise within the booth, the user will insert the pin 178 attached to a cord 180 into an aperture 182 of the appropriate weight category in order to begin performing the exercise. It will be appreciated that in other instances the exercise device may have a different system of selecting a given weight or resistance, and the user will use that system in order to select the proper weight category. The user 184, as illustrated in FIG. 25, will then perform the exercise assigned to the exercise device 22 within the booth and attempt to perform the goal-number of repetitions assigned to the given weight or resistance category. Preferably, as illustrated in FIG. 25, the electronic display screen 24 having the tutorial and the second electronic display screen 26 displaying the timer are easily viewed by the user 184 while in the booth and exercising.

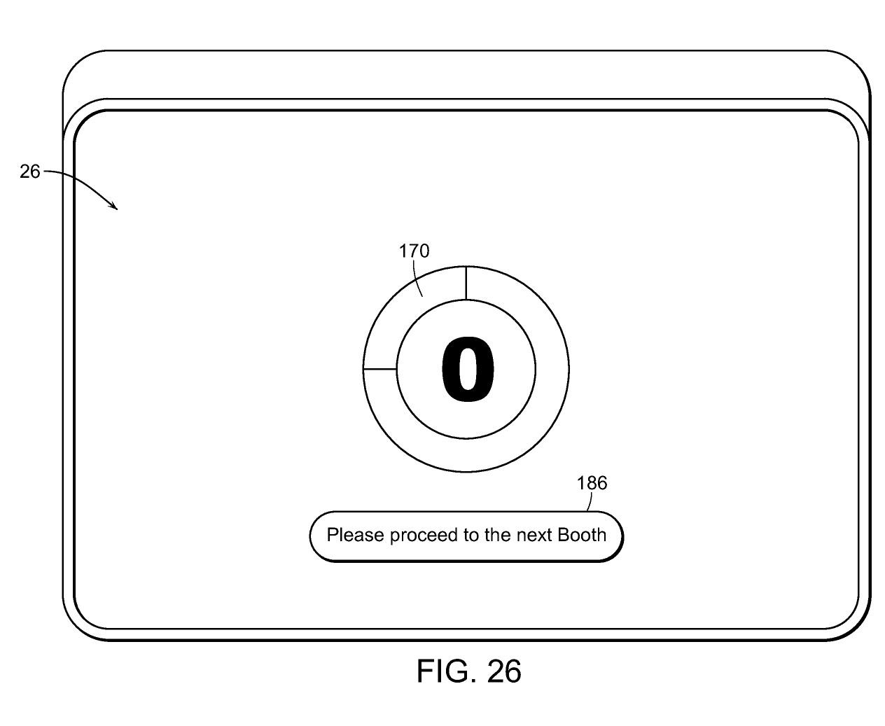

With reference now to FIG. 26, when the timer 170 indicates that the allotted time within the booth to perform the exercise has lapsed, it will visually and/or audibly give an indication of the same to the user so that the user stops exercising and moves to the next booth within the sequence. A visual and/or audio prompt 186 may also be provided to instruct the user to proceed to the next booth. In this manner, all of the users or members of the exercise facility stop exercising and move to the next booth within the sequence in a synchronized manner, which enables each user or member of the facility to exercise alone within each booth in privacy.

It is contemplated by the present invention that although the booths are used in accordance with a full body workout sequencing program, the booths instead could be used for other exercise programs. For example, a set of booths could be directed to upper body muscle groups, while another set of booths could be directed to lower body exercises, while yet another set of booths could be directed to core muscle groups, as an example. While this arrangement may not provide an optimal full body exercise regimen, it may be more desirable to some users. The concept of utilizing private booths could also be extended to other types of exercises, such as cardiovascular exercise machines, wherein each booth contains a separate treadmill, stationary bike, elliptical machine, etc. such that the user is able to perform that exercise for the prescribed or desired amount of time in a private setting, while still attending a public gym, and thus obtaining the benefits of a public workout session.

It will be appreciated that the present invention provides many advantages over current methodologies and systems. The automatically generated personalized workout provides the user with a directed workout, and allows the user to relax and have direction. There is no question as to which exercise to do next. The system simply tells the user what exercise to do, for how many repetitions and at which weight/resistance. There is no thought required as to which exercise to perform next. This results in less stress, and no waiting time for equipment. The customer may have the sense that the facility was built specifically for their own personal experience. The privacy aspect of the booths also reduces stress and distractions and allows for better concentration and a more effective workout. The booths are adaptable to the contour and layout of the building, and can be interchangeable. The booths can also present a protected environment with reduced exposure to airborne communicable diseases. Use of the booth system allows the facility to accommodate all of its users, whereas traditional gyms can only handle approximately sixty percent (60%) of their members at any given time. This is due to the fact that the users of the present invention select and book a particular time for their workout, and will know that each of the booths and exercises will be available to them at that time. However, if a large number of members of a traditional gym were to visit the gym at a particular time, those users may need to wait to access equipment and work stations. The present invention is automated, without the need of data entry or computer programs to assess and enter data. No computer data operators, or even trainers are necessary. This slashes the number of people required to run a gym dramatically. Furthermore, in a gym with as few as three sequences, three members can start every minute, or one hundred eighty members per hour. These members may not see any other members or have any interaction with them during their entire workout regimen, yet receive a highly optimized workout due to the exercise science and computerized system incorporated into the invention. Essentially, the gym member is receiving the services of his or her own personal trainer or exercise physiologist without the need of hiring one of these individuals or scheduling a time with one of these individuals or working out with one of these individuals. These inherent services within the system of the present invention could enable the gym to charge higher fees than traditional gyms.

Although several embodiments have been described in detail for purposes of illustration, various modifications may be made without departing from the scope and spirit of the invention. Accordingly, the invention is not to be limited, except as by the appended claims.

What is claimed is:

1. An exercise system, comprising:
a plurality of booths, each booth defining an enclosed space adapted to be used by a single user at a time and configured to provide privacy to the user while in the booth, each booth having assigned thereto a predetermined exercise to be performed by the user within the booth, wherein the booths include indicia or are arranged in a sequence in which the user is directed to move from one booth to another to perform different exercises corresponding to a sequence of exercises of an exercise regimen to be performed by the user;
a plurality of exercise devices disposed within a respective plurality of the booths for performing the assigned exercise within those booths; and
an electronic screen within each booth for displaying information relating to the exercise to be performed within that booth.

2. The system of claim 1, including a timer disposed within each booth for conveying to the user the amount of remaining time to complete the exercise within the booth.

3. The system of claim 2, wherein the timer comprises a second electronic screen disposed within each booth.

4. The system of claim 2, wherein the time of the timers in the booths are derived from the same source or synchronized.

5. The system of claim 1, wherein the electronic screen displays a tutorial for the exercise to be performed by the user in that booth.

6. The system of claim 1, wherein the exercise regimen for the user comprises a goal-number of repetitions of the exercise to be performed in each booth by the user within a predetermined time period.

7. The system of claim 6, wherein the exercise regimen further comprises a predetermined resistance or weight category to be used during the exercise by the user.

8. The system of claim 7, wherein each exercise device includes a categorized range of resistance or weight.

9. The system of claim 8, including resistance or weight category indicia associated with the exercise device.

10. The system of claim 9, wherein the resistance or weight category indicia comprises color coding indicia.

11. The system of claim 1, wherein the plurality of booths comprises at least five booths in close proximity or adjacent to one another.

12. The system of claim 11, wherein the plurality of booths corresponding to a sequence of exercises of an exercise regimen comprise between five booths and thirty booths disposed adjacent to one another and passed through by the user at least once during the exercise regimen to perform the sequence of exercises.

13. A process for generating and performing a personalized exercise regimen, comprising the steps of:
providing a plurality of booths each defining an enclosed space adapted to be used by a single user at a time and configured to provide privacy to the user while in the booth;
assigning each booth a predetermined exercise to be performed by the user within the booth;
placing a plurality of exercise devices within a respective plurality of the booths;
directing the user to perform a sequence of exercises by moving from one booth to another in a predetermined sequence, each exercise being assigned a time period to complete the exercise and a number of repetitions of the exercise to be performed by the user.

14. The process of claim 13, wherein the user selects a desired fitness program from a general fitness and caloric burn program, a strength enhancing program, or a performance power program.

15. The process of claim 14, including the step of assigning the user a goal-number of repetitions to be performed for each exercise within the assigned exercise time period based on the selected desired fitness program.

16. The process of claim 15, including the step of dividing a range of resistance or weight of each exercise device into a plurality of categories.

17. The process of claim 16, including the step of associating resistance or weight category indicia with each exercise device.

18. The process of claim 16, including the step of assigning a resistance or weight category to the user.

19. The process of claim 18, wherein the step of assigning the resistance or weight category includes the step of the user performing an initial fitness determination test prior to exercising.

20. The process of claim 19, wherein the initial fitness determination test comprises a grip strength test.

21. The process of claim 19, wherein the initial fitness determination test comprises performing a single repetition of an exercise at a given resistance or weight and adjusting the resistance or weight upwardly or downwardly based on a determination of an ability to complete the assigned number of repetitions.

22. The process of claim 13, including the step of displaying on an electronic screen within the booth information relating to the exercise to be performed within the booth.

23. The process of claim 13, including the step of providing a visual and/or audible notification of the time period to complete the exercise within each booth.

24. The process of claim 23, including the step of providing an electronic display in each booth having a timer derived from the same source or synchronized.
